(19) United States
(12) Patent Application Publication
(10) Pub. No.: US 2022/0058430 A1
(43) Pub. Date: Feb. 24, 2022

(54) PATTERN MODEL ASSEMBLY

(71) Applicant: Meysing Match-up Mechanisms, LLC, Austin, TX (US)

(72) Inventor: William C. Meysing, Corbett, OR (US)

(73) Assignee: MEYSING MATCH-UP MECHANISMS, LLC, Austin, TX (US)

(21) Appl. No.: 17/519,810

(22) Filed: Nov. 5, 2021

Related U.S. Application Data
(63) Continuation of application No. 16/892,151, filed on Jun. 3, 2020, now abandoned.
(60) Provisional application No. 62/856,559, filed on Jun. 3, 2019.

(51) Int. Cl. G06K 9/62; G06F 3/0484

(52) U.S. Cl. CPC G06K 9/6215; G06K 9/6202; G06F 3/04842

(57) ABSTRACT

Methods, devices, and systems for human identity pattern detection. The method may include retrieving, using at least one processor, a plurality of identity pattern statement sets from computer memory accessible to the at least one processor, wherein each identity pattern statement set of the plurality comprises a plurality of identity pattern statements; rendering a first identity pattern statement set of the plurality identity pattern statement sets for a first human; rendering a second identity pattern statement set of the plurality identity pattern statement sets to the first human; providing a user-interface configured to allow selection by the first human of a first identity pattern statement from the first identity pattern statement set and a second identity pattern statement from the second identity pattern statement set; generating a first identity pattern footprint associating the first identity pattern statement and the second identity pattern statement with a user identifier associated with the first human.

### CROSS-REFERENCE TO RELATED APPLICATION

This application claims the benefit of Provisional Patent Application Ser. No. 62/856,559, filed Jun. 3, 2019, and patent application Ser. No. 16/892,151 filed Jun. 3, 2020, both of which are incorporated herein by reference in their entirety.

### BACKGROUND OF THE DISCLOSURE

The complexities of human behavior are difficult to quantify or predict. Human interaction is often made more difficult by differences in beliefs and patterns of thought. Human interaction may be facilitated by identifying differences as well as similarities in beliefs and patterns of thought.

### SUMMARY OF THE DISCLOSURE

In aspects, this disclosure generally relates to a method for human identity pattern detection. The method may include retrieving, using at least one processor, a plurality of identity pattern statement sets from computer memory accessible to the at least one processor, wherein each identity pattern statement set of the plurality comprises a plurality of identity pattern statements; rendering a first identity pattern statement set of the plurality of identity pattern statement sets for a first human; rendering a second identity pattern statement set of the plurality of identity pattern statement sets to the first human; providing a user-interface configured to allow selection by the first human of a first identity pattern statement from the first identity pattern statement set and a second identity pattern statement from the second identity pattern statement set; generating a first identity pattern footprint associating the first identity pattern statement and the second identity pattern statement with a user identifier associated with the first human.

Methods may include rendering a representation of the first identity pattern footprint; performing a pattern matching analysis on the first identity pattern footprint using a pattern matching heuristic; rendering a third identity pattern statement set, a fourth identity pattern statement set, a fifth identity pattern statement set, a sixth identity pattern statement set, and a seventh identity pattern statement set. Each identity pattern statement set may consist of seven identity pattern statements.

Methods may include performing a pattern matching analysis on the first identity pattern footprint by comparing the first identity pattern footprint with at least one standard identity pattern footprint; determining an optimal matching identity pattern footprint from the at least one standard identity pattern footprint; and taking a diagnostic action in dependence upon the optimal matching identity pattern footprint.

Methods may include rendering the first identity pattern statement set of the plurality identity pattern statement sets for a second human; rendering the second identity pattern statement set of the plurality identity pattern statement sets to the second human; providing a user-interface configured to allow selection by the second human of a third identity pattern statement from the first identity pattern statement set and a fourth identity pattern statement from the second identity pattern statement set; generating a second identity pattern footprint associating the third identity pattern statement and the fourth identity pattern statement with a second user identifier associated with the second human. Methods may include performing a pattern matching analysis by comparing the first identity pattern footprint with the second identity pattern footprint; and taking a diagnostic action in dependence upon the pattern matching analysis. Comparing the first identity pattern footprint with the second identity pattern footprint may comprise generating a similarity metric, and the diagnostic action is dependent upon the similarity metric. The similarity metric may be dependent upon whether the first identity pattern statement is identical to the third identity pattern statement or whether the second identity pattern statement is identical to the fourth identity pattern statement. Performing a pattern matching analysis comprises using a heuristic comprising a plurality of rules.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIGS. 1A & 1B show diagrams illustrating a use case in accordance with embodiments of the present disclosure;

FIG. 2 is a diagram of systems in accordance with embodiments of the present disclosure;

FIG. 3 sets forth a block diagram of an example information processing device used in embodiments of the present disclosure;

FIG. 4 shows a flow chart illustrating methods for human identity pattern detection in accordance with embodiments of the present disclosure;

FIG. 5 shows a flow chart illustrating methods for pattern matching analysis on the first identity pattern footprint;

FIG. 6 shows a flow chart illustrating other methods for pattern matching analysis on the first identity pattern footprint.

### DETAILED DESCRIPTION

This disclosure generally relates to methods and systems for human identity pattern detection. Human identity is based on a core set of values, beliefs, and convictions, along with sociological and psychological traits. These characteristics of identity may be predictive of an individual's patterns of thought, emotion, and behavior. Thus, characteristics of identity may be indicative of (and representative of) thought, emotion, and behavior typical to the individual. Patterns in characteristics of identity, when detected, may be employed to build better teams, facilitate relations between individuals or groups of people, select well-matched companions, and provide identity-tailored (‘identity-matched’) help and instruction in a variety of areas.

Representing or expressing characteristics of identity in a beneficial or reproducible way is often challenging. One manner of representing identity is by creating a representation associating an identity of an individual or group with decisions made by the individual(s), aspects of which are described in further detail below. Individuals may be enabled to choose specific items from a finite set of alternatives by selecting the item(s). The finite set of alternatives may include items such as actions, physical objects, people, or identity pattern statements. Aspects of the present disclosure use a collection of a person's choices (that is, the selected items) to build a footprint which describes their characteristics of identity. This footprint may then be leveraged to perform the actions above.

Aspects of the disclosure include user interaction with an interface to generate a footprint. Enabling the interaction may include, for example, presenting a set of a first number of items (e.g., identity pattern statements) to a user by rendering representations of the items on a display in the context of a graphical user interface and enabling the user to select a subset of the items, comprising a second number of items, by interacting with the graphical user interface. The second number may be smaller than the first number. In particular implementations, a constraint may be applied that limits the number of items selected by placing an upper bound and/or lower bound on the number of items which may be selected. In some embodiments, constraints may allow or limit the selection of items from the set to a single selection. That is, the second number may be one (1).

Enabling the user to select a subset of the items may be carried out in any manner familiar to those of skill in the art of graphical user interfaces, such as, for example, by allowing the user to select the items in sequence using the interface until the number of selected items equals the second number, or until the user is satisfied with his or her selections. This may be carried out by activating (e.g., clicking a mouse while a cursor is on the element within the context of the GUI) an element such as an “Enter”, “Done”, or “Continue” button in the context of the GUI.

In some instances, the user may be prompted to select items in a priority order according to a provided criteria. For example, the user may be prompted to choose an item from the remaining items which the user most strongly associates with, which the user feels is most important, and so on. The user may be iteratively prompted to enter more items by iteratively choosing an item from the remaining items until the number of selected items equals the second number. Alternatively, the items may be ranked after selection.

Selected items (‘selections’) may be rendered on a display with an indication of a priority ranking in the context of a graphical user interface, and the user may be enabled to modify the priority ranking by manipulating the graphical user interface, such as, for example, by clicking and dragging or otherwise spatially reorienting GUI elements representing the items within the context of the display, by entering numerical values, toggling icons, and so on.

Additional sets are presented, and additional subsets selected. Selection and ranking information (collectively, “footprint information”) for each set are recorded and associated with the user. For example, the footprint information may be associated with a user in a database or other data structure in accordance with techniques well-known in the art, such as, for example, managing data held in a relational database management system with a structured query language (SQL).

FIGS. 1A & 1B show diagrams illustrating a use case in accordance with embodiments of the present disclosure. Referring to FIG. 1A, in turn, sets of items 101 are rendered for selection (e.g., visually on a display, played over speakers or headphones, etc). The first set 100 includes seven items 101a-101f (collectively, “101”). Participants make choices 102a-102d (collectively, “102”) from the options in each set. An additional selection may be performed from the initial four selections for each set, such as, for example, choosing the most representative choice 102d from the initial choices 102 (collectively, the “additional selections”). Several sets may be used, and each set may be organized around a central theme. The additional selection may be performed in sequence after selection of choices 102 and prior to enabling selection of items from the next set. This configuration may allow for faster selection. Alternatively, some or all of the remaining sets may be rendered to allow selection of initial choices 102 from each set in turn, followed by the additional selection from the selected choices for each set. This configuration may allow for a deeper (e.g., more accurate, more representative, more emotionally impactful, and so on) experience while identifying the additional selection. After the additional selection, an auxiliary selection may be enabled, wherein the user selects an ultimate subset (e.g., four choices) from the additional selections from all the sets.

Each choice (item) may be an identity pattern statement 103a-103g (collectively, “103”), which is an item reflective of one or more characteristics of identity. The identity pattern statement may be a statement which the user identifies as meaningful to the user, the user agrees with, and so on. The term statement is not limited to a collection of words, and may also include single words. In fact, the identity pattern statement may comprise any of word(s), images, graphical components, auditory components (e.g., sounds and music), or combinations of these elements. In some embodiments, the statement may be a famous quote, a goal, or an objective.

FIG. 1B is a diagram illustrating sets 111a-111g (collectively, “111”) and choices 102 of a footprint 120 in accordance with embodiments of the present disclosure. Participants may first select four statements in each set. Each set may contain seven statements, and there may be seven sets, although other configurations will occur to those in the art.

In a teambuilding example, the seven sets may correspond with sequenced stages of teamwork success themes, resulting in a 28 quote choice pattern. The teamwork success themes for the sets are Time Management/Service 111a, Collaboration/Cumulative Results 111b, Commitment/Loyalty 111c, Challenge/Momentum 111d, Follow-Through/Recognition 111e, Beliefs/Convictions 111f, and Planning/High Performance 111g. Thus the fingerprint may be representative of chosen teamwork success quotes, for example. The pattern represents each participant's personal vision and attitudes about work, team unity, and job performance commitment.

After the selection of initial choices 102 and/or the most representative choice 102d from each of the sets 111, a secondary ranking or selection of the initial choices 102 facilitated and recorded as part of the footprint. For example, from the choices 102d from seven sets 111, the user may be directed to select the most representative choice. Alternatively, an additional number (e.g., 2, 3, 4 or 5) of choices may be selected from the most representative choices 102d from each of the sets 111 and then ranked.

The footprint information of each participant may be compared with each other or with a team leader. A tally may be kept of how many of a particular participant's 28 quote selections match-up with those of another footprint, such as, for example, other team members, the team leader, or a standard. A footprint match may occur upon the tally reaching or exceeding a threshold (e.g., 15), which may indicate a unity deepening connection—between the particular coworker and the team leader, for example. Different thresholds may be used for each set.

An operator may be notified upon detection of a footprint match. The operator may be the user, an employer, a supervisor, a human resources team member, and so on. The operator may also be a computer agent process. Upon detecting a footprint match, additional actions may be triggered, as described in greater detail below.

Software executing on one of a variety of environments may embody the methods described herein.

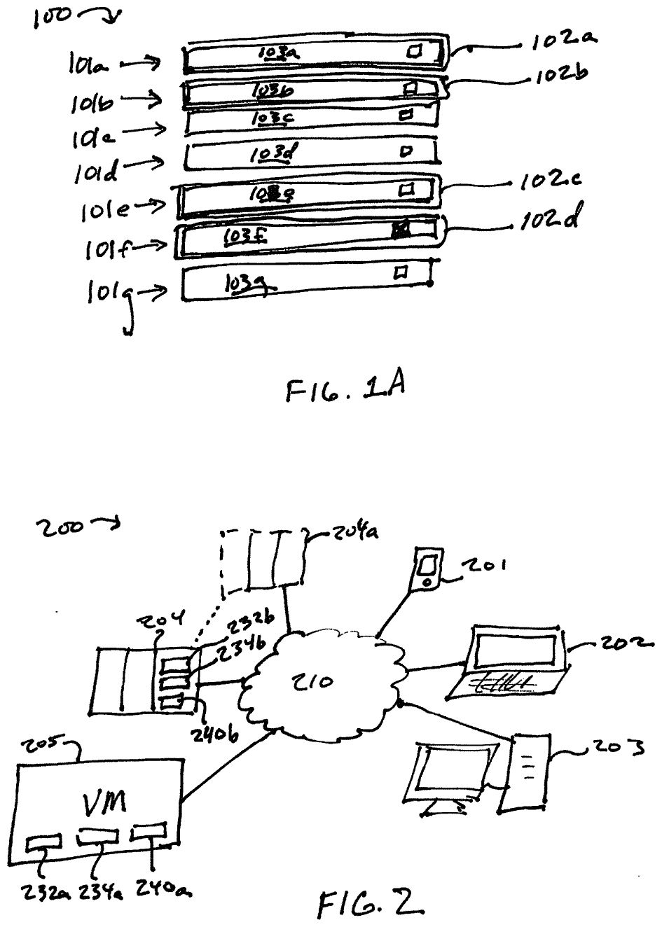

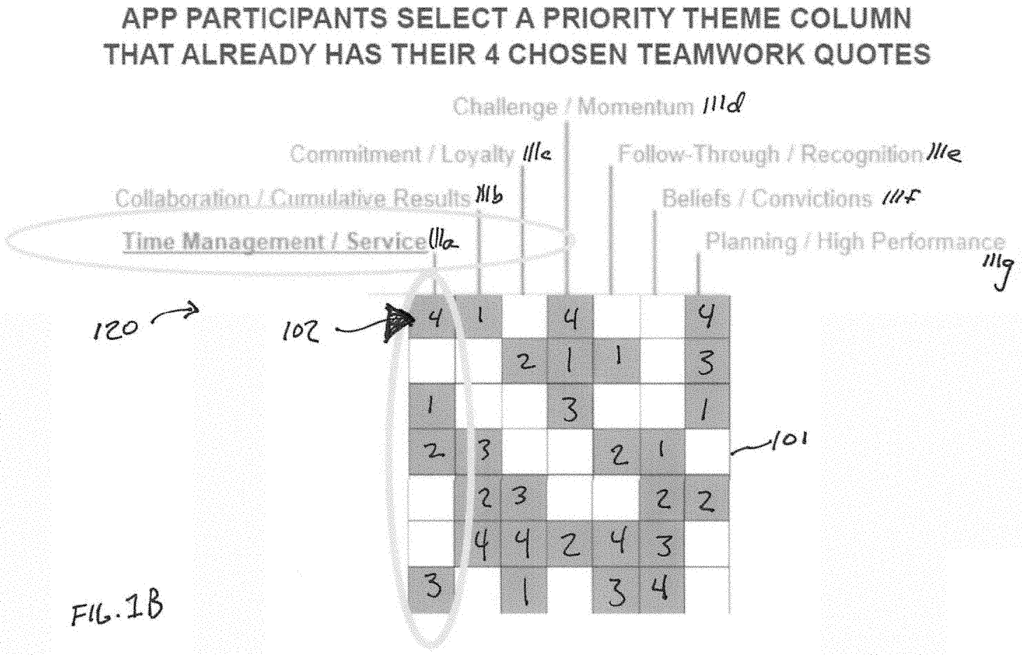

FIG. 2 is a diagram of systems in accordance with embodiments of the present disclosure. The pattern matching system 200 includes a number of devices 201-205 connected by network(s) 210 for data communications. The network(s) 210 of system 200 includes wide area networks (‘WANs’), such as the Internet, local area networks (‘LAN’s), intranets, internets, wireless networks, cellular networks, or any other type of communication network, or combinations of these.

A first client device 201 is in connection with a pattern matching server 204, and is used by a first human. Similarly, a second client device 202 is also in connection with pattern matching server 204. In other embodiments, client devices may connect to additional third-party servers 204a, which are in connection with the pattern matching server, which serves as a central platform. For example, third party service providers may act as a front-end providing input to and passing through (or leveraging) the results from pattern matching server 204. The client devices may be personal computers accessing the pattern matching server 204 through a web browser interface, mobile devices 201 utilizing downloaded app software, or any other distributed software framework. Some data may be warehoused on the mobile device or computer. In addition to, or in place of pattern matching server 204, virtual machines 205 may be employed to implement pattern matching servers. Virtual machines 205 may be, for example, cloud architecture implementations including one more cloud computing services implemented through data centers, such as, for example, Microsoft Azure provided by Microsoft Corporation, Amazon Web Services provided by Amazon.com, Incorporated, Google Cloud Platform provided by Google LLC, IBM Cloud provided by International Business Machines Corporation, Oracle Cloud Infrastructure provided by Oracle Corporation, and so on.

Client devices 202, 212 may be any of a desktop, workstation, laptop, smartphone, smart television, tablet, cellular telephone, and the like. Client devices 202, 212 may log in to servers (by using a web browser or a client application, for example) to enable the respective users to make selections of identity pattern statement, receive diagnostic information, view analysis, view matching users, and so on.

Servers and virtual machines may include web servers and/or application servers connected to a database in local or remote storage. Devices 201-205 may store and manage account information, client preferences, and footprints. Devices 204 and/or 205 may include an analysis engine 232a, 232b, an action generator 234a, 234b, and a graphical user interface module 240a, 240b. The analysis engine 232 may detect similarities and differences between a user footprint and other user footprints, including standard footprints indicative of a diagnostic type. The analysis engine 232 may detect a match by comparison of the footprint of each participant, as described above. Also, the analysis engine 232 may compare footprints and/or the detected differences or similarities therein against a set of rules to characterize the user or to characterize a relation between users.

The action generator 234 performs diagnostic actions in dependence upon the analysis. The action generator 234 may also use system configuration data, historical data, reference data, preference data, device location data, device usage data, and so on, in diagnosing the appropriate action. Actions may be generated in dependence upon one or more inputs using one or more rules (a rule base). These data may be stored locally or in network attached storage in various databases. In some examples data may be polled from devices. The action generator 234 may include an inference engine or semantic reasoner. The action generator may employ a match-resolve-act cycle to perform diagnostic action.

Example actions may include notification of an optimal match, notification of a match within a threshold range, including identifying data for matching users ranked in accordance with the strength of the match using numerical or rule-based matching criteria, rendering of the footprint, rendering of a characterization of the user or a relation between users (e.g., difference and/or similarities between two or more footprints, prompting for additional data entry, transmitting additional information associated with analysis result, and so on. The action generator 234 may direct the rendering of additional text, video, or other elements in dependence upon the footprint, the analysis, and so on. The action generator 234 may direct the rendering and selection of a specific set 111 (or sets) of identity pattern statements 103a-103g in dependence upon the analysis, the footprint, a portion of the footprint, and the like.

The following pseudo-code illustrates an example where two users are matched by an implementation of the present disclosure serving as an unmoderated matchmaking service for personal connection between individual users.

```
determineMatch(userID1, userID2)
  comparePresentFootprintArray(userid1,userid2, total_ItemMatch)
  if total_ItemMatch >= threshold_ItemValue
    createMatchLink(userID1,userID2)
```

First, the process determineMatch is called, passing a unique global identifier associated with each user to be tested for a match. The unique global identifier is used to access respective arrays containing all the item selections for each set for each of the users. If the individual entries in the array for each user are the same, an additional array may be created indicating the positive results for each comparison. The total value of the array may then be determined and returned as “total_ItemMatch.” If this returned value is greater than the set threshold value “threshold_ItemValue”, then the two users are associated together as matched companions by calling the createMatchLink function and passing the user identifiers. The value of threshold_ItemValue may be set by an administrator, by actions of the user, based on match thresholding rules, and so on. Association of the users may be implemented by including user identifiers in the same match table entry, by listing the user ID of a matching user in a data structure associated with the user, and so on, and may be carried out using arrays, pointers, lookup tables, or other data structures known in the art.

Match thresholding rules are predetermined instructions for assigning values to threshold_ItemValue or other variables in dependence upon parameters of interest. Match thresholding rules may assign the value based on user data (such as, for example, user characteristics), system use data, time of day, user preferences, and other factors as will occur to those of skill in the art. Selections of the most representative items may likewise be saved in an array and used for comparison. Various algorithms may be implemented using rule logic to determine whether two users have sufficiently the same selections to qualify as a match. In some versions, selection of a match may require additional conditions, such as fitting companion preferences indicated by the user and saved in a configurations file or other preference mechanism.

Graphical user interface (‘GUI’) module 240 formats information from action generator for rendering at a client device. Data may be formatted as propriety or non-proprietary data sets for specially configured rendering by client software on the client device, or as HTML, XHTML, Flash, or other web-compatible data formats for rendering with a web browser such as Mozilla Firefox, Opera, or Google Chrome. Security module 250 may also conduct authentication and authorization procedures for anyone using the software.

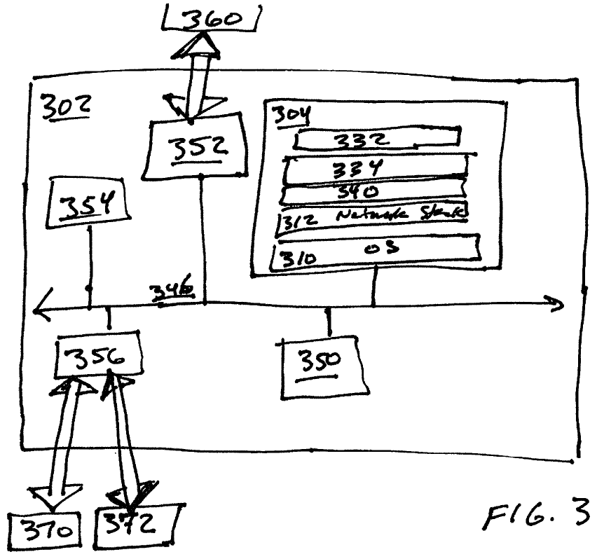

The system may implement databases in data storage. The data storage may include any non-transitory computer-readable medium, either remotely or locally accessible, implemented with architectures including but not limited to cloud storage, network attached storage, storage area networks, etc. FIG. 3 sets forth a block diagram of an example information processing device used in embodiments of the present disclosure. Computer 302 includes at least one computer processor 354 as well as a computer memory, including both volatile random access memory (‘RAM’) 304 and some form or forms of non-volatile computer memory 350 such as a hard disk drive, an optical disk drive, or an electrically erasable programmable read-only memory space (also known as ‘EEPROM’ or ‘Flash’ memory). The computer memory is connected through a system bus 346 to the processor 354 and to other system components. Thus, the software modules are program instructions stored in computer memory.

An operating system 310 is stored in computer memory. Operating system 310 may be any appropriate operating system such as Windows 10, Windows 11, Mac OSX, UNIX, or LINUX, or mobile operating systems such as iOS, Windows Phone, or Android. A network stack 312 is also stored in memory. The network stack 312 is a software implementation of cooperating computer networking protocols to facilitate network communications. Memory 304 may include an analysis engine 332, action generator 334, and a graphical user interface module 340. Memory 304 and/or 350 may also contain data structures representing footprints of each participant for comparison, standard footprints, configurations files, and so on.

Computer 302 also includes one or more input/output interface adapters 356. Input/output interface adapters 356 may implement user-oriented input/output through software drivers and computer hardware for controlling output to output devices 372 such as computer display screens, as well as user input from input devices 370, such as keyboards and mice.

Computer 302 also includes a communications adapter 352 for implementing data communications with other devices 360. Communications adapter 352 implements the hardware level of data communications through which one computer sends data communications to another computer through a network.

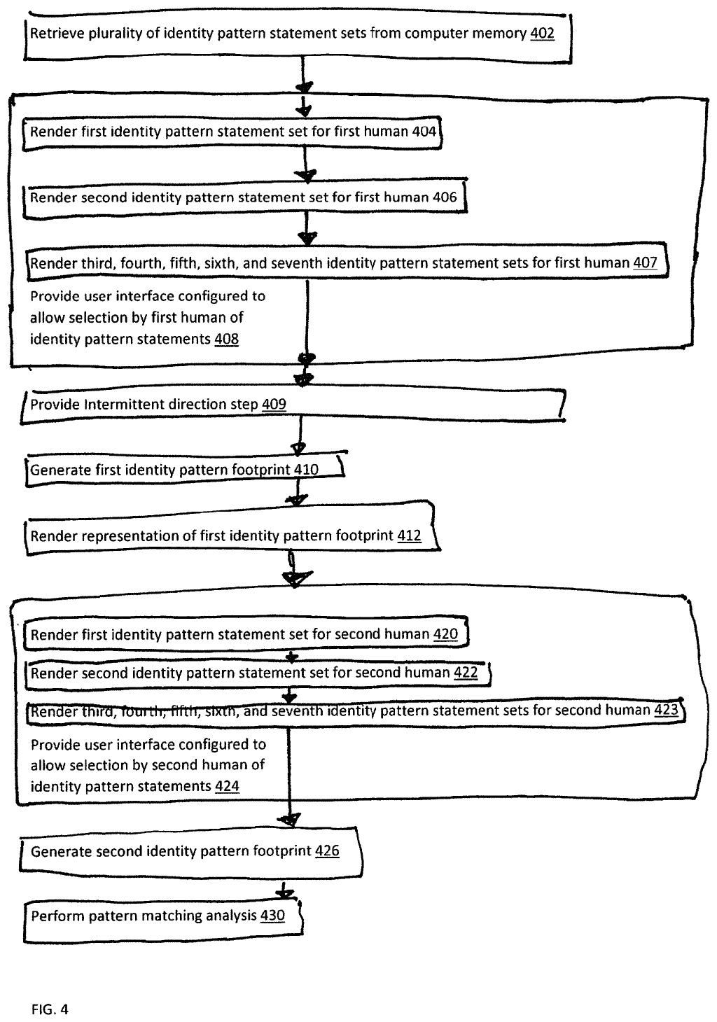

FIG. 4 shows a flow chart illustrating methods for human identity pattern detection in accordance with embodiments of the present disclosure. Methods may include, at a first step 402, retrieving, using at least one processor, a plurality of identity pattern statement sets from computer memory accessible to the at least one processor. Each identity pattern statement set of the plurality comprises a plurality of identity pattern statements. Step 404 comprises rendering a first identity pattern statement set of the plurality identity pattern statement sets for a first human. Step 406 comprises rendering a second identity pattern statement set of the plurality identity pattern statement sets to the first human. Each identity pattern statement set may consist of seven identity pattern statements. Step 408 comprises providing a user-interface configured to allow selection by the first human of a first identity pattern statement from the first identity pattern statement set and a second identity pattern statement from the second identity pattern statement set. Optional step 407 comprises rendering a third identity pattern statement set, a fourth identity pattern statement set, a fifth identity pattern statement set, a sixth identity pattern statement set, and a seventh identity pattern statement set.

As one example, the rendering and selection may be implemented via a user interface in the context of a web page displayed using a web browser. For example, a page coded in HyperText Markup Language (‘HTML’) may be displayed by the web browser running on a client device. The HTML code may include HTML elements that are the building blocks of the page. With constructs in the HTML document, images and other objects such as interactive forms may be embedded into the rendered page, such as, for example, by using JavaScript libraries, the HTML <form> element, and so on. Forms may be combined with programs written in various programming language to create dynamic web sites. Either or both of client-side and/or server-side languages may be employed.

Intermittent direction step 409 may optionally be provided in the graphical user interface in response to selection of identity pattern statements. This step directs further action by the user. Step 409 may include collection of further input from the user.

For example, embodiments may include an intermittent direction step for the user following input of the ranked choices, which may, for example, directs the user to re-read the top four choices in sequence beginning with the fourth most important choice and ending with the most important choice, and then input text for the user's reasons for selection of that choice as the most important. The text may then be saved in memory as an experiential record associated with the user. The direction step may direct further input by the user to effect a ranking of the selected choices, or to designate those choices which are most desirable or representative, or to direct the user to enter additional information through the user interface in response to a specific choice.

Step 410 comprises generating a first identity pattern footprint associating the first identity pattern statement and the second identity pattern statement with a user identifier associated with the first human. Optional step 412 comprises rendering a representation of the first identity pattern footprint.

Optional step 420 may include rendering the first identity pattern statement set of the plurality identity pattern statement sets for a second human. Optional step 422 may include rendering the second identity pattern statement set of the plurality identity pattern statement sets to the second human. Optional step 424 may include providing a user-interface configured to allow selection by the second human of a third identity pattern statement from the first identity pattern statement set and a fourth identity pattern statement from the second identity pattern statement set. Optional step 423 comprises rendering a third identity pattern statement set, a fourth identity pattern statement set, a fifth identity pattern statement set, a sixth identity pattern statement set, and a seventh identity pattern statement set. Optional step 426 may include generating a second identity pattern footprint associating the third identity pattern statement and the fourth identity pattern statement with a second user identifier associated with the second human.

Optional step 430 comprises performing a pattern matching analysis on at least the first identity pattern footprint. Performing a pattern matching analysis on the first identity pattern footprint may be carried out using a pattern matching heuristic. The heuristic may comprise a plurality of rules.

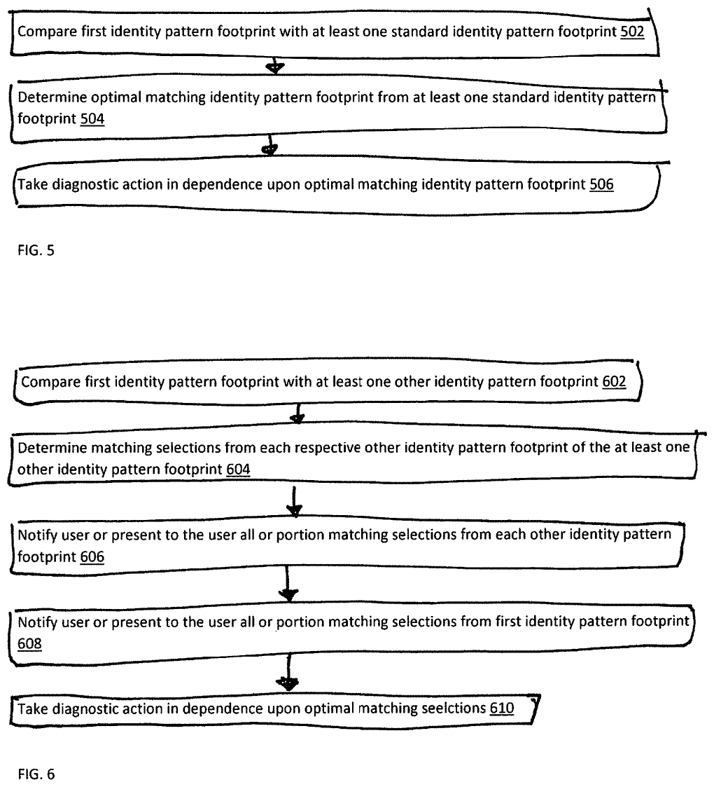

FIG. 5 shows a flow chart illustrating methods for pattern matching analysis on the first identity pattern footprint. Methods may include step 502, comparing the first identity pattern footprint with at least one standard identity pattern footprint. Step 504 may include determining an optimal matching identity pattern footprint from the at least one standard identity pattern footprint. The at least one standard identity pattern footprint may be correlated with particular sets of identity characteristics or personality types of interest. Step 506 may include taking a diagnostic action in dependence upon the optimal matching identity pattern footprint. For example, step 506 may prescribe an identity-dependent set of activities, mental exercises, affirmations, points of emphasis for success, questions to answer, goals, touchstones, pitfalls, strategies, or the like, or combinations of these.

Comparing the first identity pattern footprint with the second identity pattern footprint may be carried out by generating a similarity metric. The diagnostic action may be generated dependent upon the similarity metric. The similarity metric may be dependent upon whether the first identity pattern statement is identical to the third identity pattern statement. The similarity metric may be dependent upon whether the second identity pattern statement is identical to the fourth identity pattern statement.

FIG. 6 shows a flow chart illustrating other methods for pattern matching analysis on the first identity pattern footprint. Methods may include step 602, comparing the first identity pattern footprint with at least one other identity pattern footprint. The first identity pattern footprint may be associated with a user such as a supervisor in a work relationship, a new employee, a new or prospective member of a group, and so on. Step 604 may include determining matching selections from each respective other identity pattern footprint of the at least one other identity pattern footprint which are similar to the first standard identity pattern footprint. Optional step 606 may include notifying the user or presenting to the user all or a portion the matching selections from each other identity pattern footprint having a matching selection, a threshold number of matching selections, or a sufficiently similar footprint as determined above. Thus, members of the same organization may be able to see how they are alike. Optional step 608 may include notifying the other users or presenting to the other users all or a portion the matching selection from the first identity pattern footprint. Optional step 610 may include taking a diagnostic action in dependence upon the matching selections from each respective other identity pattern footprint of the at least one other identity pattern footprint. For example, other users having a sufficiently high number of matching selections or whose footprints are otherwise determined as sufficiently similar may be paired with the first user as mentors or the like. Alternatively, users may be notified of particular potential synergies or pitfalls which may result between them based one differences in selections using a personality interaction diagnostic heuristic.

One diagnostic action is the display of selected identity pattern statements in a contemplation enhancing graphical context, such as, for example, display of the ultimate subset selected by the user from the additional selections as described above in a three dimensional monolith. As one example, each item from the ultimate subset and/or information relating to the these items may be displayed on the faces of a four-sided regular tetrahedron. The regular tetrahedron rotates or is rotatable by the user in the context of the GUI to better examine each face. In some examples, each face may be rotated through in a particular sequence in order to integrate logical and intuitive processing and recognition of the identity pattern statements and/or additional related information. The sequence may be prescribed by a priority of the initial sets, by user ranking of the statements, or combinations of these according to various weighting algorithms.

The flow diagrams depicted herein are just an example. There may be many variations to these diagrams or the steps (or operations) described therein without departing from the spirit of the invention. For instance, the steps may be performed in a differing order, or steps may be added, deleted or modified. All of these variations are considered a part of the claimed invention.

The term “information” as used above includes any form of information (analog, digital, EM, printed, etc.). The term “processor” or “information processing device” herein includes, but is not limited to, any device that transmits, receives, manipulates, converts, calculates, modulates, transposes, carries, stores or otherwise utilizes information. Implicit in the control and processing of the data is the use of a computer program on a suitable non-transitory machine readable medium that enables the processors to perform the control and processing. An information processing device may include a microprocessor, resident memory, and peripherals for executing programmed instructions. The processor may execute instructions stored in computer memory accessible to the processor, or may employ logic implemented as field-programmable gate arrays (‘FPGAs’), application-specific integrated circuits (‘ASICs’), other combinatorial or sequential logic hardware, and so on. The term processor is intended to include devices such as ASICs. Thus, a processor may be configured to perform one or more methods as described herein, and configuration of the processor may include operative connection with resident memory and peripherals for executing programmed instructions.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional actions for actions described herein. Such insubstantial variations are to be considered within the scope of the claims below.

While one or more embodiments have been shown and described, modifications and substitutions may be made thereto without departing from the spirit and scope of the invention. Accordingly, it is to be understood that the present invention has been described by way of illustrations and not limitation.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The terms “first” and “second” are used to distinguish elements and are not used to denote a particular order.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. A method for human identity pattern detection, the method comprising:
retrieving, using at least one processor, a plurality of identity pattern statement sets from computer memory accessible to the at least one processor, wherein each identity pattern statement set of the plurality comprises a plurality of identity pattern statements;
rendering a first identity pattern statement set of the plurality identity pattern statement sets for a first human;
rendering a second identity pattern statement set of the plurality identity pattern statement sets to the first human;
providing a user-interface configured to allow selection by the first human of a first identity pattern statement from the first identity pattern statement set and a second identity pattern statement from the second identity pattern statement set;
generating a first identity pattern footprint associating the first identity pattern statement and the second identity pattern statement with a user identifier associated with the first human.

2. The method of claim 1 further comprising rendering a representation of the first identity pattern footprint.

3. The method of claim 1 further comprising performing a pattern matching analysis on the first identity pattern footprint using a pattern matching heuristic.

4. The method of claim 1 further comprising rendering a third identity pattern statement set, a fourth identity pattern statement set, a fifth identity pattern statement set, a sixth identity pattern statement set, and a seventh identity pattern statement set.

5. The method of claim 4 wherein each identity pattern statement set consists of seven identity pattern statements.

6. The method of claim 1 further comprising performing a pattern matching analysis on the first identity pattern footprint by comparing the first identity pattern footprint with at least one standard identity pattern footprint; determining an optimal matching identity pattern footprint from the at least one standard identity pattern footprint; and taking a diagnostic action in dependence upon the optimal matching identity pattern footprint.

7. The method of claim 1, further comprising:
rendering the first identity pattern statement set of the plurality identity pattern statement sets for a second human;
rendering the second identity pattern statement set of the plurality identity pattern statement sets to the second human;
providing a user-interface configured to allow selection by the second human of a third identity pattern statement from the first identity pattern statement set and a fourth identity pattern statement from the second identity pattern statement set;
generating a second identity pattern footprint associating the third identity pattern statement and the fourth identity pattern statement with a second user identifier associated with the second human.

8. The method of claim 7 further comprising performing a pattern matching analysis by comparing the first identity pattern footprint with the second identity pattern footprint; and taking a diagnostic action in dependence upon the pattern matching analysis.

9. The method of claim 8 wherein comparing the first identity pattern footprint with the second identity pattern footprint comprises generating a similarity metric, and the diagnostic action is dependent upon the similarity metric.

10. The method of claim 9 wherein the similarity metric is dependent upon whether the first identity pattern statement is identical to the third identity pattern statement.

11. The method of claim 10 wherein the similarity metric is dependent upon whether the second identity pattern statement is identical to the fourth identity pattern statement.

12. The method of claim 7 wherein performing a pattern matching analysis comprises using a heuristic comprising a plurality of rules
